(19) United States
(12) Patent Application Publication
(10) Pub. No.: US 2023/0366168 A1
(43) Pub. Date: Nov. 16, 2023

(54) WIND UPLIFT-RESISTANT SURFACE COVER SYSTEMS AND METHOD

(71) Applicant: Watershed Geosynthetics, LLC, Alpharetta, GA (US)

(72) Inventors: William Delaney Lewis, West Monroe, LA (US); Carl M. Davis, III, Canton, GA (US); Jose L. Urrutia, Suwanee, GA (US); Kyle S. Ehman, Milton, GA (US)

(73) Assignee: Watershed Geosynthetics, LLC, Alpharetta, GA (US)

(21) Appl. No.: 18/029,555

(22) PCT Filed: Jan. 10, 2021
(86) PCT No.: PCT/US2021/053097

§ 371 Date: Mar. 30, 2023

Related U.S. Application Data
(60) Provisional application No. 63/086,581, filed on Oct. 1, 2020.

(51) Int. Cl. E02D 31/00; E04D 5/10; B32B 5/02; B32B 3/30; B32B 5/06

(52) U.S. Cl. CPC E02D 31/006; B32B 3/30; B32B 5/028; B32B 5/073; E04D 5/10; E02D 2200/13; E02D 2300/0051; E02D 2300/0092

(57) ABSTRACT

A cover system for preventing water ingress having a geomembrane layer and a wind-disturbing open-pore layer thereon and defining an asperity extent, said open-pore layer for forming in situ an air-flow turbulence zone between the geomembrane layer and a boundary space proximate the open-pore layer as a transition from turbulent flow of wind in the turbulence zone to laminar flow of the wind remote from the geomembrane layer, said open-pore layer inducing disturbance of a wind flow into and through the layer, whereby a suction force on the geomembrane is disturbingly broken by turbulent wind shear events therein and exerted downward pressure deflections, wherein the wind speed and pressure differential lessen and the geomembrane resists uplift. A method of covering a large area surface with a cover system that resists wind uplift is disclosed.

### TECHNICAL FIELD

The present invention relates to cover systems that overlay large surface areas for closing the surface to inflow and seepage of ambient water and precipitation, for surface area covering such as roof surfaces and land sites. More particularly, the present invention relates to cover systems that overlay large area surfaces for restricting flow of ambient water, rain, and precipitation into the covered surface while resisting wind uplift of the cover system during service as the closing overlay.

### DEFINITIONS

In this application, the following terms will be understood to have the indicated definitions:

Asperity extent - refers to an uneven discontinuous distal portion of an open-pore wind disturbing layer which layer experiences turbulent air flow through the layer and proximate the asperity extent.

Geoomembrane - refers to conventional structured polymeric-material sheets, such as high density polyethylene, very low density polyethylene, linear low density polyethylene, polyvinyl chloride, and similar, provided as an impermeable sheet for liner and cover purposes of large area surfaces, such as roofing and in the waste site and land site industries; geomembranes useful with the present invention may be smooth or textured (such as surface treatment or extending projections).

Pore space - significant open pore space or apertures defined by interconnected fiber strands characterize the wind-disturbing layer for air flow therethrough.

Undulating - in some exemplary embodiments, the distal outward edge of the wind disturbing layer defines a rising and falling form or outline at the asperity extent; a sinuous or wavelike edge of open-pore alternating ridges and valley portions, such as a wavy form or surface or a bend with successive curves in alternate directions.

Waste sites - refers to earthen berms or piles and to sites where waste is deposited, such as landfills, phosphogypsum stacks, environmentally impacted land, leach pads, mining spoils and environmental closures or material stockpiles that require a closure or cover system to protect proximate and remote environments such as local subsurface ground and ground water table and downstream waterways and bodies and subsurface ground.

Wind shear - refers to resultant forces arising from a change in wind speed or wind direction in close proximity to a cover system for a large area surface, which may have vertical changes or horizontal changes relative to the cover system.

Uplift - refers to the tendency of a sheet member to develop a pressure differential between an upper surface and lower surface of the sheet member, such that the pressure underlying the sheet member is greater than the pressure overlying the sheet member and thereby cause the sheet member to move upwardly.

Roofs or roof tops - refers to closing portion of a building structure, typically a large area planar surface for closing an upper portion of a building envelope, and may be interrupted with through-roof projections such as standpipes and with box-type housings or structures such a HVAC units, blower ports or vents housings, utilities access devices, and such.

### BACKGROUND OF THE INVENTION

Elongated sheets find gainful use as covers for large surface areas such open area ground sites, waste sites, and roof structures. Ground covers are used for covering large land sites, such as landfills and waste areas. The ground covers may have short term coverage purposes such as a temporary closing/covering an area of a landfill (for example up to about 10 years cover life period) prior to completing the landfill and closing with a more long-term “permanent” ground cover system (for example, 50 or more years of cover life). Often, as waste sites are used by receiving waste materials for long-term storage, there is a need for temporary closure of filled portions of the waste site (i.e., for a period of time typically several years but perhaps as long a 10 or 15, but prior to a permanent long-term extended duration closure.)

A covering closure for landfill or waste site traditionally deposited an overburden layer of soil of several feet depth. This however is expensive, time consuming, and environmentally unsatisfactory, with multiple trucks moving soil onto the site and on-going maintenance to cut and remove vegetation that provides water infiltration paths as well. Steep sided landfill sites were further subject to erosion that created water channels and washed away deposited soil that had to be replenished. Alternatively, impermeable geomembrane sheets have been deployed. The impermeable sheets include tarp materials (10 to 15 mil scrim-reinforced polyethylene sheets) and more robust geomembranes (60 mil polyethylene sheets, or in applications under European regulations of 80 mil - 100 mil, or greater) as ground cover. The impermeable ground cover prevents water flow, such as from rain, from seeping into ground water below the covered land area. Rather, water is directed to flow-off the typically steep sided terrain into channels or culverts for diverting to water treatment facilities and discharge to water systems.

These heavier geomembrane sheets, for example, 40 - 60-mil high-density polyethylene liner, may be employed as either short- or long-term capping system. The liner is provided on-site as in rolls of an elongated sheet. The rolls are positioned and unrolled with adjacent sheets seamed together to form a large area ground cover. Seaming may be accomplished with sewing, thermal welding, or taping. Sewing is less preferable as providing potential leak paths for water that can form eroded troughs or channels in the ground. Troughs and channels can contribute to stress on the geomembrane particularly under wind loading and may cause damage and tears. An operational responsibility is prompt repair of minor tears to prevent wind entry underneath the ground cover, and with wind, water that causes erosion and scouring below the ground cover. Lighter-weight and thinner rainsheets or tarps provide lower material costs but increased installation as needing more closely spaced anchoring to reduce tension in the cover during use.

More importantly however, these large-area sites are subject to significant wind flow and resultant wind uplift. The shear forces of wind on the extending sheet ground covers causes uplift and movement of the ground cover. To prevent movement caused by wind uplift, ground covers may be secured in place with anchorage systems. Generally, anchorage systems are directed to horizontally oriented anchors (i.e., anchor system extending along a latitude line spaced relative to a base of the covered site), vertically oriented anchors (i.e., anchor system extending typically vertically but generally extending from a lower portion of the site to a vertically higher surface point), and secondary anchors. Horizontally oriented anchors include swales typically for water collection and drainage and roadways for motor vehicle access to a ground site, for example, for further deposits, for maintenance, or for monitoring. Examples of vertical anchor systems include down-chutes or landfill gas collection trenches. Secondary anchorage systems include weighting devices distributed in spaced relation over the cover system, for example, sandbags or with tires tied together with ropes. Such is expensive, unsightly, and difficult to install and maintain. A 6.7 psf uplift pressure requires 60 pound sandbags on 3 foot centers, or approximately 4,800 sandbags per acre. Tires are lighter, which require more close spacing. A combination may be used but each anchorage requires cabling and cable anchorage to maintain on sloped surfaces. An important factor is design criteria particularly for wind speed. Field installations of rainsheets with anchorage of tires and sandbags on 7 foot to 10 foot centers may perform coverage functions in winds up to about 40 miles per hour (a typical maximum annual wind speed in many inland locations.) Earthen anchors have been developed but the risks in driving the anchor through the cover sheet material resulting in a water flow paths and leakage have limited the use of such devices,

Accordingly, there is a need in the art for an apparatus and method for reducing exposure of large surface area cover systems to wind-lift and movement. It is to such that the present invention is directed.

### BRIEF SUMMARY OF THE PRESENT INVENTION

The present invention meets the need in the art for a cover system for overlaying a large area surface as a closing cover to prevent ambient water, such as from rain and flood waters from inflow and seepage into the covered surface while resisting wind uplift of the cover system during the covering service. More particularly, the present invention comprises a cover system of a geomembrane layer and a wind disturbing open-pore layer that defines an asperity extent for forming in situ an air-flow turbulence zone between the geomembrane layer and a boundary space proximate the open-pore layer, which boundary layer defines a transition from turbulent flow of wind in the turbulence zone to laminar flow of the wind remote from the geomembrane layer. The porosity of the open-pore layer induces disturbance of a wind flow into and through the layer and breaks suction on the geomembrane, which disturbance and breaking arises from wind shear events therein such that the wind speed and suction (pressure differential) reduce and exert downward pressure deflections, wherein the geosynthetic resists uplift from wind loading.

Objects, advantages, and features of the present invention will become apparent upon a reading of the following detailed description in reference to the drawings.

### BRIEF DESCRIPTION OF THE DRAWINGS

FIG. 1 illustrates in front elevational exploded view a cover system for use overlaying a surface for covered protection in accordance with the present invention.

FIG. 2 illustrates in perspective view the embodiment of a cover system illustrated in FIG. 1 having an air disturbing layer in accordance with the present invention.

FIG. 3A illustrates in perspective view an alternate embodiment of the air disturbing layer.

FIG. 3B illustrates in front elevational view the alternate embodiment of the air disturbing layer shown in FIG. 3A.

FIG. 4 illustrates in perspective view a sloped ground site and installation of the ground cover in accordance with the present invention.

FIG. 5 illustrates in perspective view an alternate embodiment of the air disturbing layer.

FIG. 6 illustrates in perspective view an alternate embodiment of the air disturbing layer.

FIG. 7A illustrates in a perspective view photograph and FIG. 7A-1 illustrates in perspective view drawing an alternate embodiment of the air disturbing layer.

FIG. 7B illustrates in front elevational view photograph and FIG. 7B-2 illustrates in perspective view drawing the alternate embodiment of the air disturbing layer shown in FIGS. 7A and 7A-1.

FIG. 8 illustrates in perspective view an alternate embodiment of the air disturbing layer.

FIG. 9 illustrates in perspective view an alternate embodiment of the air disturbing layer.

FIG. 10 illustrates in perspective view an alternate embodiment of the air disturbing layer.

FIG. 11A illustrates an embodiment of a cover system having an air disturbing layer in accordance with the present invention.

FIG. 11B illustrates the cover system illustrated in FIG. 11A in cross-sectional elevational view.

FIG. 12 illustrates a manufacturing system for extrusion of a geomembrane and overlay of an air disturbing layer for tacking portions of the fibers of the air disturbing layer to an upper surface of the geomembrane.

FIG. 13 illustrates a perspective view of a ground cover system having a geomembrane and an overlay of an air disturbing layer in accordance with the present invention.

### DETAILED DESCRIPTION

It is been determined surprisingly, and unexpectedly, that a light-weight, high-pore opening asperity-defining wind-disturbing structural blanket, layer, fabric, or mesh assembly of fibers, generally randomly laid, which fibers may interconnect at contacting points as short contacting strands of fibers, vertically-thick elongated assembly overlaid on a geomembrane sheet providing a cover system for protecting a surface from in-flow of water from rain or other precipitation into the surface and subsurface, reduces wind-uplift shear forces on the geomembrane, as a wind resistant layer that defines an asperity extent for forming in situ an air-flow turbulence zone between the geomembrane layer and a boundary space proximate the open-pore layer, which boundary layer defines a transition from turbulent flow of wind in the turbulence zone to laminar flow of the wind remote from the geomembrane layer. The porosity of the open-pore layer induces disturbance of a wind flow into and through the layer and breaks suction on the geomembrane, which disturbance and breaking arises from wind shear events therein such that the wind speed and suction (pressure differential) reduce and exert downward pressure deflections, wherein the geosynthetic resists uplift from wind loading.

In embodiments of the disclosed cover system, the mesh comprises a plurality of random laid fibers forming a vertically-thick, elongated assembly overlaid on the geomembrane, and in illustrative embodiments, tackingly attached at spaced-connections therebetween. The fibers occupy a minor portion of the thickness of the assembly and define in a majority portion of the thickness a plurality of air-flow pathways through the open-pore layer. In illustrative embodiments, the fibers interconnect at contacting connections of proximate strands of fibers. The upper surface of the geomembrane in illustrative embodiments defines a texturing for a mechanical connection between the geomembrane and the open-pore layer. In an alternate embodiment, the geomembrane further comprises a plurality of spaced-apart projections extending from the upper surface, said projections for mechanically connecting the geomembrane and the open-pore layer together. In a further alternate embodiment cover system, the geomembrane further comprises a plurality of spaced-apart stubs extending from an opposing bottom surface, for mechanical engagement of the geomembrane to a penetrable surface, such as ground of a waste site or for mechanical joinder to a roof structure.

An illustrative cover system installation comprises at least two elongated geomembranes disposed in adjacent relation and bonded together at adjacent opposing edges; and at least two elongated layers overlaid on the geomembranes and disposed in adjacent relation, each of said two elongated layers having respective side edge portions, and the side edge portion of a first one of the two elongated layers overlapping the side edge portion of a second one of the two elongated layers.

Illustrative embodiments of the open pore layer comprises a base mesh layer and an attached superstructure layer, said base mesh layer connecting to the upper surface of the geomembrane and said superstructure layer comprising a volumetric open-pore profile of fibers that define the asperity extent remote from the geomembrane. In illustrative embodiments, the base layer is substantially planar. Further, the volumetric open-pore profile has in illustrative embodiments a variable thickness along a longitudinal axis of the elongated layer, whereby the layer defines an undulating profile. The undulating profile may comprise alternating ridges and valleys.

Further, the assembly in illustrative embodiments comprises a geotextile disposed between the base layer and the superstructure layer. The geotextile may comprise a plurality of fiber sticks distributed between the base layer and the superstructure layer. In an illustrative embodiment, the plurality of fiber sticks may be carried on a netting, and the netting, the base layer, and the superstructure layer engaged together. An illustrative embodiment comprises a sewed thread interwoven through the assembly for engaging the netting, the base layer, and the superstructure layer together.

Alternatively an illustrative embodiment provides a bottom portion of the open-pore layer that bonds at spaced-apart contacting points to the geomembrane. The geomembrane may define surface texturing. An embodiment of the bonded open-pore layer defines a flap on a side edge portion that is unbonded to the geomembrane, which flap is displaceable for passage of a seaming device for joinder of opposing edges of adjacent geomembranes.

The invention accordingly is directed to a cover system of a water impermeable geomembrane and a wind resistant layer that significantly and materially reduces the effect of wind shear of wind flow over a large area surface onto which the cover is installed. The wind resistant layer comprises a blanket, layer, fabric, or mesh assembly of fibers or interconnected strands of fibers (mesh, air laid non-woven, woven textile) having a high percentage of open pore space, a distal asperity extent remote from the geomembrane, and a relative thickness for defining a height of the distal asperity extent spaced from the underlying geomembrane. During installed use of the cover covering a large surface area, wind flow over the covering system becomes disturbed (i.e., creates turbulence) proximate the wind resistant layer. The wind resistant layer causes a turbulent airflow in a uplift-resisting boundary air flow channel through the wind resistant layer and proximate the asperity extent to a turbulent boundary extent where the turbulent flow changes to laminar wind flow over the covered surface, which turbulent wind flow proximate the geomembrane resists uplift of the geomembrane by reducing the shear force effect on the geomembrane.

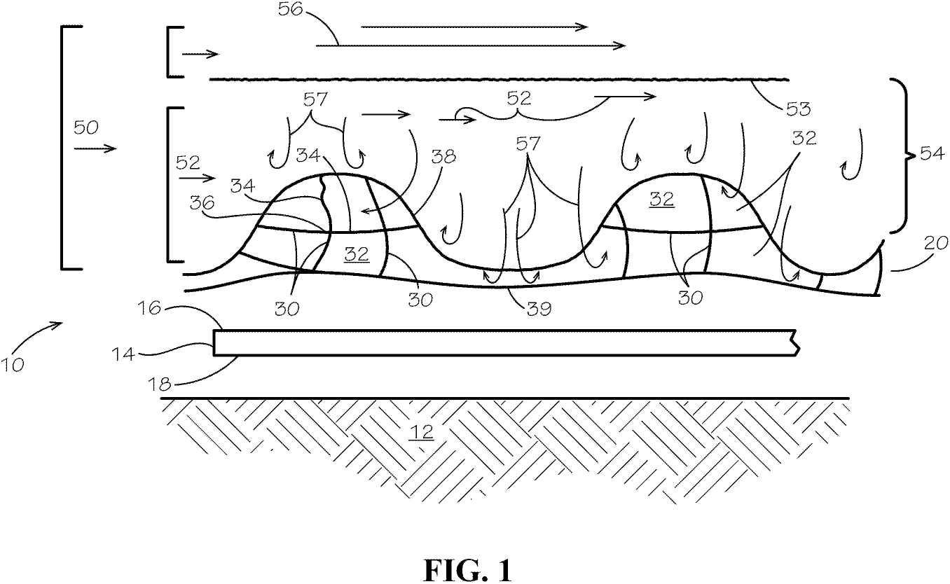

The following discloses illustrative embodiments of the present cover system in association with a ground site application although the cover system is readily applicable for use with other large area surfaces, for example, roofs. With reference to the drawings in which like parts have like identifiers, FIG. 1 illustrates a ground cover system 10 in accordance with the present invention for overlying a large area non-vegetated land surface or ground 12 and providing increased resistance to wind-uplift of the ground cover system in response to high velocity wind flow over the ground cover. The ground cover system 10 comprises a geomembrane 14 having an upper surface 16 and a lower surface 18 that contacts a ground surface. The geomembrane 14 typically is an elongated sheet provided in a selected width as a rolled material of a selected length, for unrolling and disposing over the ground surface. A wind-disturbing layer 20 overlies the geomembrane 14 on the upper surface 16. The wind-disturbing layer 20 is characterized as a light-weight, high pore opening asperity-defining structural blanket, layer, fabric, or mesh assembly of random laid fibers, which fibers may interconnect as short strands of fibers attached or bonded at contacting points, as a vertically-thick elongated assembly. The wind-disturbing layer 20 induces in situ turbulence of wind an air-flow turbulence zone between the geomembrane layer and a boundary space proximate the open-pore layer and with a separation or gap between the geomembrane 14 and a boundary layer of laminar flow wind, which boundary layer defines a transition from turbulent flow of wind in the turbulence zone to laminar flow of the wind remote from the geomembrane. The separation moves the shear forces vertically from proximity to the geomembrane, which shear forces that otherwise tends to induce wind-uplift and wind-induced movement of the geomembrane overlying the ground surface.

It is to be noted that the layer comprises a mesh of a plurality of random laid fibers forming a vertically-thick, elongated assembly. The fibers occupy a minor portion of the thickness of the assembly and define in a majority portion of the thickness a plurality of air-flow pathways through the open-pore layer. The fibers may interconnect at contacting points of the strands of fibers. The fibers define a mesh with a high open pore structure.

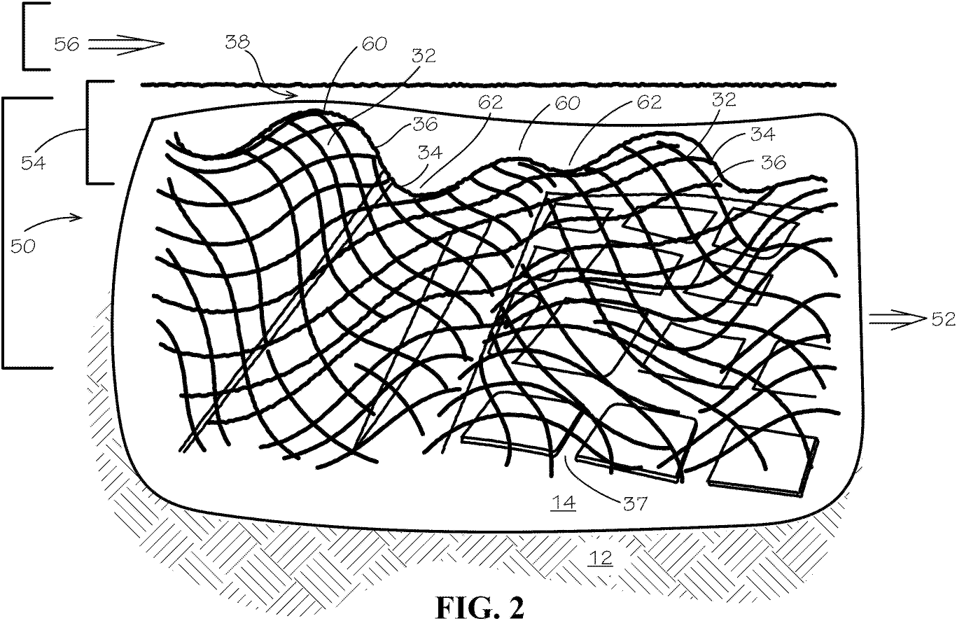

FIG. 2 illustrates in upper perspective view the embodiment of the cover system 10 illustrated in FIG. 1 having the air disturbing layer 20 overlying the geomembrane 14 on a surface 12 in accordance with the present invention. The wind-disturbing layer 20 comprises a plurality of fibers 30 interspersed or disposed together to define opening or pores 32 therebetween and through the layer. In the illustrated embodiment, the wind-disturbing layer 20 joins the fibers 30 as a mesh structure of strands 34 overlapping, and in illustrative embodiments, joined at respective portions as interconnection 36 with other of the strands, and thereby defining the pores 32 in the layer. A distal edge 35 (i.e., the outermost edge of the mesh superstructure spaced remote from the geomembrane 14), of the wind-disturbing layer 20 defines an asperity extent 38. The asperity extent 38 is spaced from an opposing bottom edge 39 which sits in contact with the upper surface 16 of the geomembrane 14. The asperity extent 38 defines an uneven discontinuous distal portion of the open-pore wind disturbing layer 20.

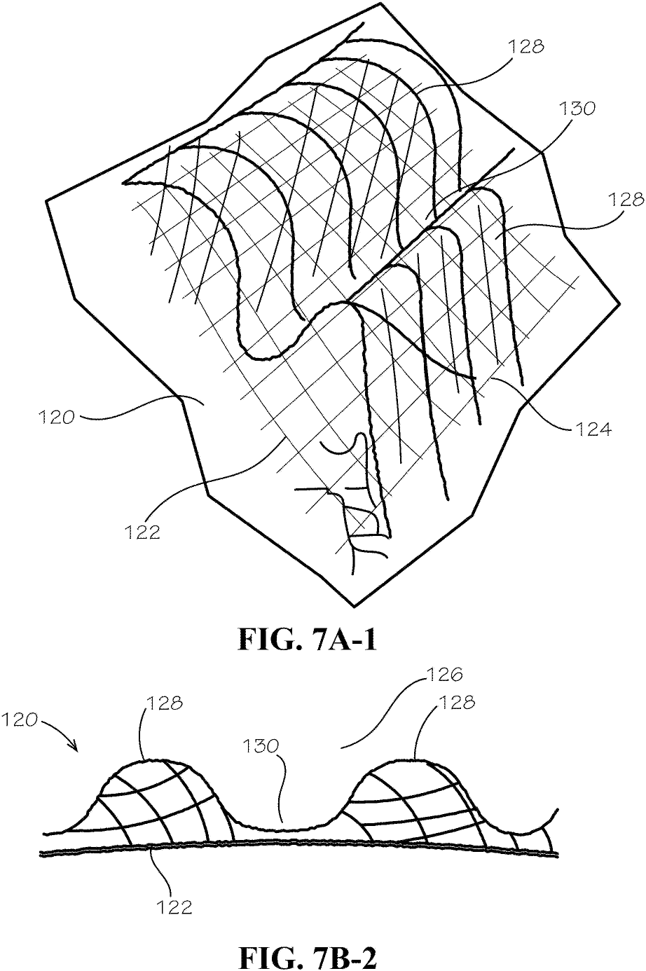

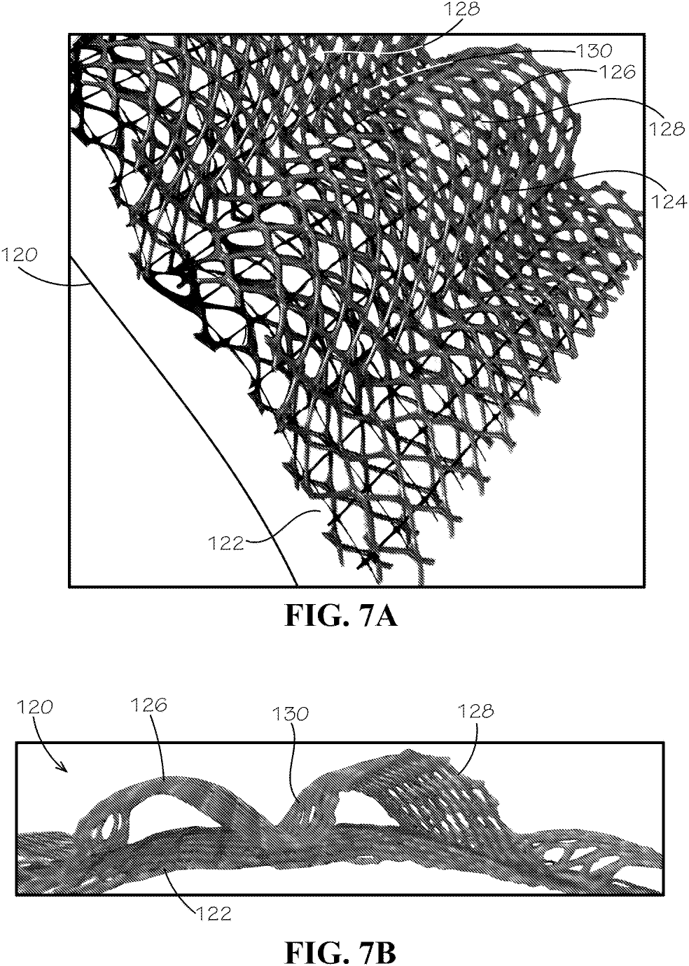

FIG. 2 also illustrates the wind-disturbing layer 20 optionally overlying and attached to a grid-matrix mesh 37 of interconnected lands defining openings, which mesh 37 provides a stable base or frame for the wind-disturbing layer, for example, the base mesh layer 122 in the illustrative embodiment of FIG. 7A discussed below. In a particular application for allowing ambient environmental water such as from rain fall or snow, for example, to flow below grade, the mesh 37 overlies the ground surface directly without use of the geomembrane 14, and the size of the defined openings is based on a desired water flow into the ground.

During use of the ground cover system 10, a wind 50 flows across the land site 12 covered by the ground cover system 10. The wind 50 flows into the wind-disturbing layer 20 through the pores 32 and across the cover system 20 and the geomembrane 14. The wind-disturbing layer 20 induces in situ turbulent wind 52 within a wind turbulence zone 54. The wind turbulence zone 54 is within the wind-disturbing layer 20 and proximate the wind-disturbing layer including from the asperity extent 38 to a wind transition boundary line 53 vertically spaced remote from the geomembrane 14. The wind above the wind transition boundary line 53 is laminar flow 56. The greater the vertical distance spacing of the boundary line 53, and thus, the spacing of the laminar flow 56, from the geomembrane 14, the less suction shear force is applied by the wind flow to the ground cover 10 and particularly to the water impermeable geomembrane. Further, the downward wind forces bend the ridges downwardly. The wind turbulence 52 forms localized flows and jetties 57 of wind proximate the wind-disturbing layer. The ridges interrupt the wind flow and resulting shear force of the turbulent wind in the turbulence zone tends to cause the mesh structure to bend or deflect downwardly producing a downward force or pushing on the geomembrane 14 below the wind-disturbing layer 20. This increases the resistance of the ground cover system to wind-uplift. The laminar flow 56 is vertically spaced from the geomembrane and the pulling of the shear force of the wind is significantly reduced. The wind-disturbing layer 20 effectively develops in situ a wind-shield structure deferring the laminar flow wind 56 from wind shear onto the geomembrane. The ground cover system 10 thereby resists wind-uplift that causes movement of the geomembrane without the need of additional ballasting, anchorage, or the like.

The asperity extent 38 may define for the wind-disturbing layer 20 in an illustrative embodiment an undulating profile or alternately, a substantially planar profile. In the illustrative embodiment shown in FIG. 2 perspective view and as a non-limiting example, the asperity extent defines the distal edge of the wind disturbing layer 20 as a rising and falling form or outline, or a sinuous or wavelike edge of open-pore alternating ridges 60 and valley 62 portions, such as a wavy form or surface or a bend with successive curves in alternate directions. In an alternate embodiment, the wind-disturbing layer 20 may be planar. The wind-disturbing layer 20 may be mesh, woven, non-woven, or air-laid fiber fabric, having a thickness defining open pores and passages through the fiber defined layer, as more particular disclosed in illustrative embodiments discussed below.

The relative cross-sectional area of the open pore 32 is predominate, such that wind flows through the open pores through the wind-disturbing layer 20. The wind velocity is reduced in the turbulence zone 54 relative to the wind velocity of the laminar flow, reducing wind uplift forces by the open pores breaking suction forces of the flowing wind over the geomembrane with jetties 57 applying downward pressures to the geomembrane, for resisting wind uplift of the geomembrane of the cover system overlying a large surface area such as a land site or roof.

The thickness of the wind disturbing layer 20 between the bottom 39 and the asperity extent 38 may further contribute to the effectiveness of the layer 20 in breaking of the wind 50 into turbulence 52 proximate the geomembrane and laminar flow 56 vertically spaced above the wind transition boundary line 54. The laminar flow 56 remote from the geomembrane 14 has reduced, or limited, shear on the geomembrane. As a result, adjacent panels of the cover system may abut without a need for joinder or attachment such as by welding, bonding, connecting together with fasteners or joiners, or other interlinking devices. The geomembrane of the cover system thereby remains as placed on the ground surface adhered by the turbulence 52.

The wind-disturbing layer 20 in accordance with the present invention is a pronounced, 3-d mesh, blanket, matting, or layer, formed of textile fibers, polypropylene fibers, polyethylene fibers, or the like, that creates tremendous resistance to the effects of wind with an adhesion-type reaction on the geomembrane for wind uplift resistance. Generally, wind-disturbing layers 20 useful in accordance with the present invention feature the following characteristics:
product height (to define a large buffer volume between the upper surface of the geomembrane and the asperity extent and further to the wind transition boundary line 54 for protecting the underlying geomembrane for resisting wind flow shear forces)
pore space (larger pore openings within the wind-disturbing layer 20 provides for air flow movement, and prevents vacuum pressure (lift) from building on wind-disturbing layer and the underlying geomembrane; a larger effective pore volume defined by the openings and passages in and through the wind disturbing layer facilitates air flow and resists wind shear vacuum pressure (lift) and the building-up of vacuum on the underlying geomembrane that causes uplift movement)
asperity of the effective distal edge or surface of the air disturbing layer (the uneven discontinuous distal portion of the open-pore wind disturbing layer enhances the turbulence right above the surface of the air layer product, this results in a layer of air serving as a windshield).

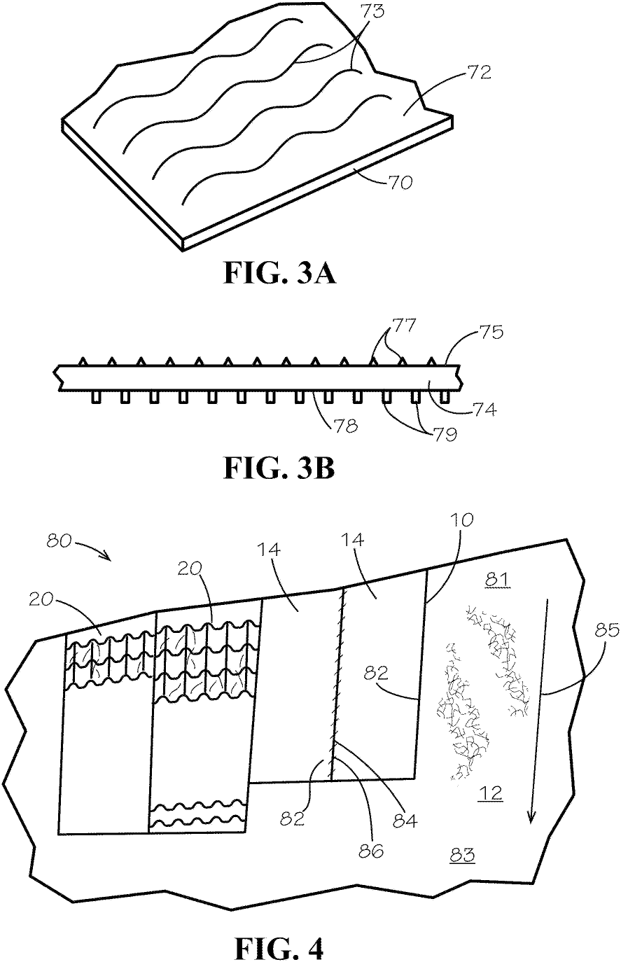

FIG. 3A illustrates in perspective view an alternate embodiment geomembrane 70 in which the upper surface 72 includes a texturing 73, for example, grooves, to provide a roughened surface. The texturing of the geomembrane may be formed by calendaring the geomembrane during manufacturing. The texturing 73 provides a mechanical connection between the geomembrane 70 and the wind-disturbing layer 20.

FIG. 3B illustrates in elevational view an alternate embodiment geomembrane 74 in which the upper surface 75 includes a plurality of spaced-part projections 77 such as pointed members. The opposing bottom surface 78 includes a plurality of spaced-apart projecting stubs 79. The projections 77 provide a mechanical engagement of the geomembrane 74 with the wind-disturbing layer 20. The stubs 79 provide a mechanical engagement to a penetrable surface, such as the ground 12 of a waste site An alternate embodiment uses one of either of the plurality of projections 77 or the plurality of the stubs 77 but selectively not both projections and stubs.

FIG. 4 illustrates in perspective view a sloped ground site 80 and installation of the ground cover 10 in accordance with the present invention. The geomembrane 14 typically is manufactured in a selected width and provided on-site as an elongated rolled sheet of a selected length. The geomembrane 14 is installed from an upper or uphill portion 81 of the terrain surface downwardly downhill to a lower portion 82 as indicated by the arrow 85. Additional lengths of the geomembrane 14 are positioned in adjacent relation. Opposing edges 82, 84 of adjacent geomembranes 14 may be joined together such as by heat sealing or welding to provide an impervious joint in the geomembrane of the ground cover 10. In the illustrated embodiment, the wind-disturbing layer 20 similarly is provided as a rolled fabric and installed onto the geomembrane in adjacent longitudinal mats. The width of the wind-disturbing layer 20 may be different than the width of the geomembrane to avoid aligned edges of the overlaid geomembrane. The installation of the wind-disturbing layer 20 does not require ballasting such as with sandbags, tires and ropes, anchorages, cement blocks or other mass devices for holding the geomembrane 14 from movement under wind loading. Adjacent lengths of the wind-disturbing layers 20 may be positioned with abutting opposing side edges or may positioned in overlapping relation with a respective side portion of one length overlapping a side portion of the adjacent wind-disturbing layer. Although not necessary, the perimeter edges of the leading and trailing ends of the wind-disturbing layers 20 may be buried in a trench as a termination point.

An illustrative cover system comprises at least two elongated geomembranes disposed in adjacent relation and bonded together at adjacent opposing edges; and at least two elongated layers overlaid on the geomembranes and disposed in adjacent relation, each of said two elongated layers having respective side edge portions, and the side edge portion of a first one of the two elongated layers overlapping the side edge portion of a second one of the two elongated layers

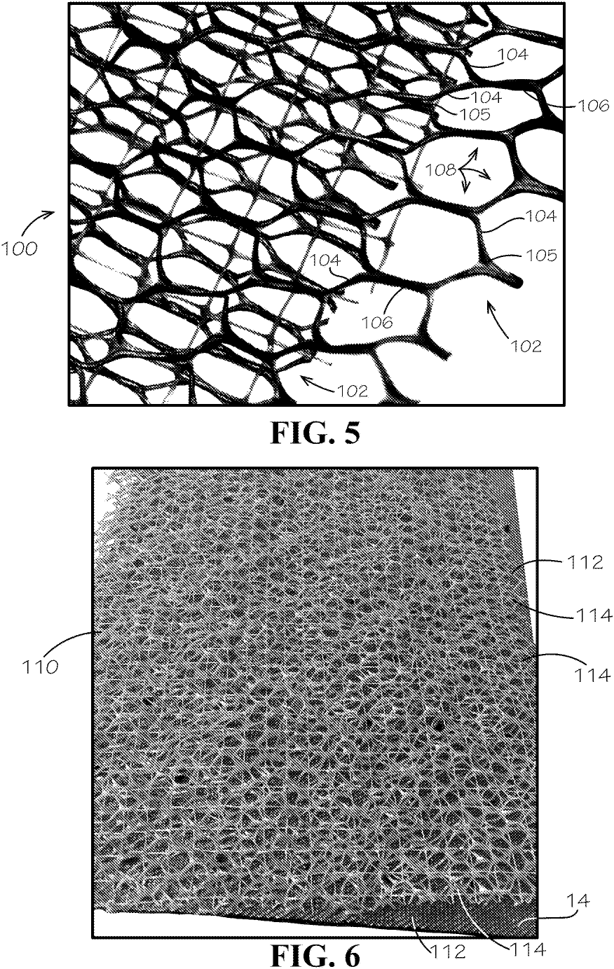

FIG. 5 illustrates in perspective view an alternate embodiment of an air disturbing layer 100 of a plurality of open-pore mesh sheets 102 overlaid one over another. The mesh sheets 102 have elongated strands 104 extending from a junction 105 to join an adjacent strand in a common portion 106, which strands 104 and common portion 106 define open pores 108. In the illustrated embodiment the strands 104 extending at angles and the common strand 106 define a hexagonal open pore. Other pore shapes such as circular, square, rectangular for example, may be formed as the mesh sheet. The plurality of overlaid sheets 102 define layers of mesh sheets in a stack, and the openings of the mesh sheets thereof define passages through the air disturbing layer 100 for turbulent flow therethrough.

FIG. 6 illustrates in perspective view an alternate embodiment of the air disturbing layer 110 formed of a plurality of open-pore mesh sheets 112, for a structured layer of open pores 114 that permit turbulent air flow through and over the air disturbing layer. The air disturbing layer 110 overlies the geomembrane 14.

FIG. 7A illustrates in a perspective view photograph and FIG. 7A-1 illustrates in perspective view drawing an alternate embodiment of the air disturbing layer 120 having a base mesh layer 122 and a superstructure mesh 124 attached to the base mesh layer 122. The base mesh layer 122 and the superstructure mesh 124 assemble together to form a volumetrical vertically-thick open-pore elongated layer having a base that sits on the geomembrane 14 and a profile or shape configuration for defining the asperity extent remote from the geomembrane. The superstructure mesh 124 extends to a profile extent 126. The profile extent 126 in the illustrated embodiment provides the superstructure mesh 124 with a varying thickness between the base mesh layer 122 and the profile extent. This defines an undulating profile with alternating ridges 128 and valleys 130. In an alternate embodiment, the profile defines spaced pyramid-like projections. In an alternate embodiment, the thickness is substantially uniform for an open-pore planar profile. The mesh is composed of polypropylene or polyethylene monofilament yarns, with high UV resistance.

FIG. 7B illustrates in front elevational view photograph and FIG. 7B-2 illustrates in perspective view drawing the alternate embodiment of the air disturbing layer 120 shown in FIGS. 7A and 7A-1 to illustrate the substantially planar base mesh layer 122 and the extending superstructure mesh 124 attached to the base mesh layer defining the alternating ridges 128 and valleys 130. An alternate embodiment uses the superstructure mesh alone that has a lower edge that seats on the geomembrane while the profile extent defines the remote asperity extent of the profile. The profile may be substantially planar, undulating, or more structured spaced ridges and valleys. Wind-resistant layers of the illustrative embodiment have about 8.0 to 14.0 ounces per square yard (271 grams per square meter) with a thickness of about 0.25 inches to about 0.5 inches, and a tensile strength of about 150 pounds per foot, or more, for example 600 pounds per foot, or for extreme wind designs having a thicker profile to about for example 1800 pounds per foot for high strength resistance, and an elongation of about 20% to 40%. The air-disturbing layer preferably is made with materials having high UV resistance to reduce degradation and damage to the layer by exposure to sun.

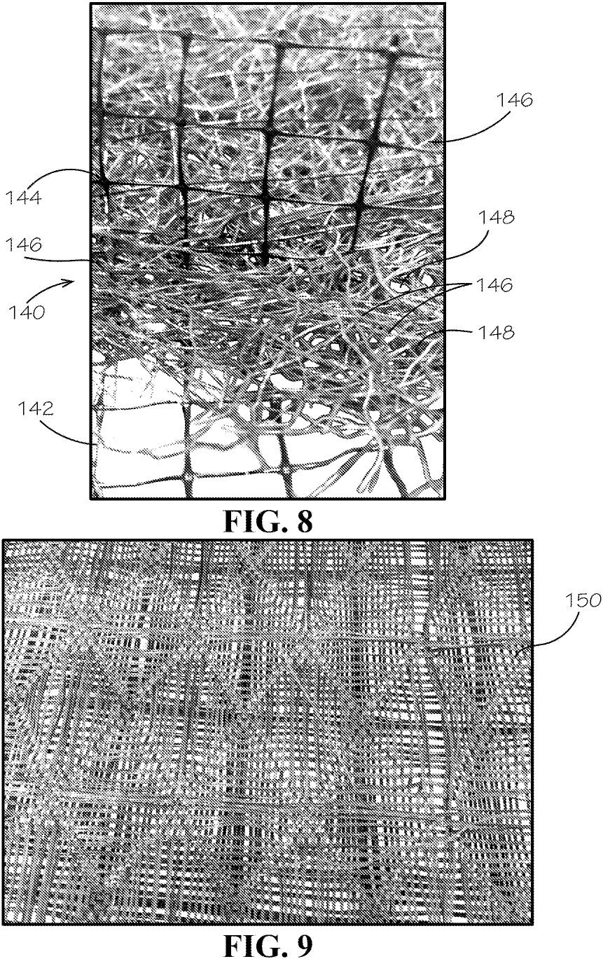

FIG. 8 illustrates in perspective view an alternate embodiment of the air disturbing layer 140 as a blanket having opposing open mesh layers 142, 144 and a plurality of fibers 146, which fibers may be discrete sticks distributed and disposed therebetween, for defining open-pore turbulence passageways 148 through the layer. The opposing open mesh layers with sandwiched fiber sticks provides a three-dimensional and/or stitchbonded geotextile, such as made with a polypropylene or similar, as a dimensionally stable rollable product for handling and transportation to an install site. A portion of the upper mesh layer 144 is illustrated angled upwardly from the layer 140 for purposes of viewing the fiber sticks 146; generally, the opposing mesh layers 142, 144 are substantially parallel to sandwich the fiber sticks 146 therebetween. The fiber sticks may be a plastic simulated wheat straw mechanically bound and covered on a netting, for example polypropylene, with mesh openings of approximately ⅜ inch by ⅜ inch (11 millimeter × 11 millimeter). The opposing layers and fiber sticks may be sewed together for blanket stability, for example, on a 2 inch center with a polypropylene thread. The blanket may be between 8 and 14 ounces per square yard, with a thickness of about 0.35 to 0.5 inches, or more, up to about 3 inches, and a light penetration of 5% to about 40%. The thickness may be selectively increased for a design for a ground cover application that may experience a high wind velocity, whereby the increased thickness increases the wind resistance to meet differing wind design criteria.

FIG. 9 illustrates in perspective view an alternate embodiment of the air disturbing layer 150 of a plurality of thick-strand open-pore mesh formed as a three-dimensional lofty woven geotextile. The layer 150 is provided with a selected thickness for defining a profile extent having the asperity extent of the layer whereby air flow through the layer forms the turbulent air flow proximate the geomembrane to the boundary layer to the laminar flow which boundary layer is remote from the profile extent.

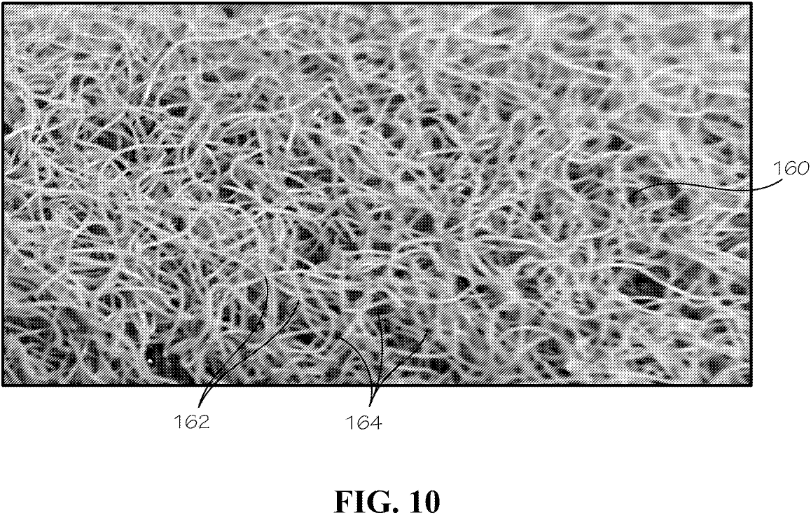

FIG. 10 illustrates in perspective view an alternate embodiment of the air disturbing layer 160 formed of a plurality of air-blown fibers 162 to form a plurality of air passageways 164 in a fiber blanket. The fiber blanket overlies the geomembrane for in-situ formation of the turbulent wind flow proximate the geomembrane and through the air disturbing layer to the boundary with the laminar wind flow remote from an asperity extent.

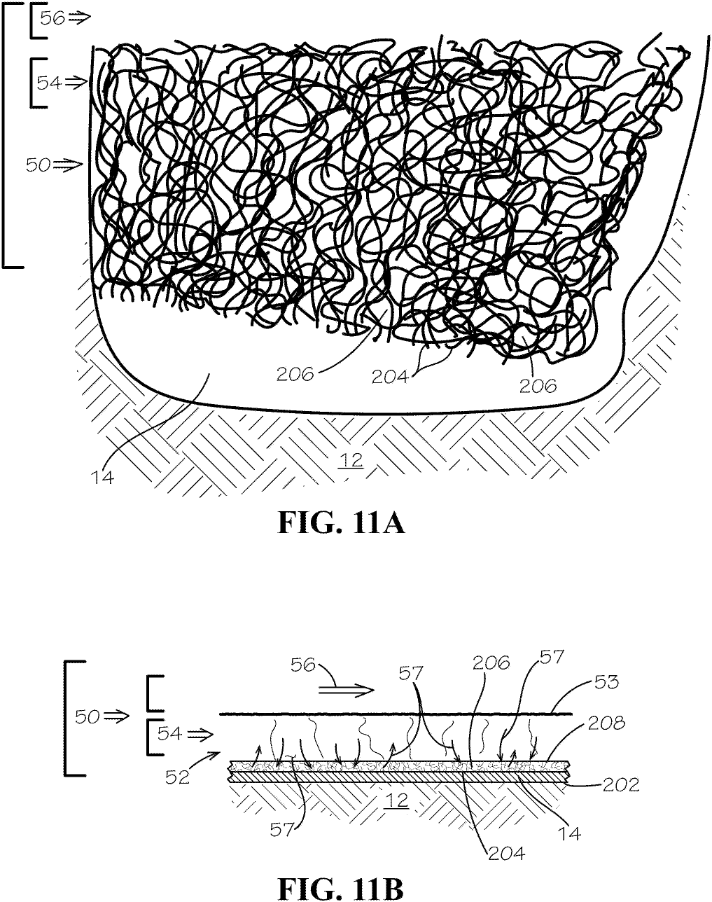

FIG. 11A illustrates an embodiment of a cover system having an air disturbing layer in accordance with the present invention.

FIG. 11A illustrates an alternate embodiment in accordance with the present invention for a cover system 200 for overlying a large area surface 202, such as a roof or non-vegetated land surface or ground, and providing resistance to wind-uplift of the cover system in response to high velocity wind flow over the ground cover.

FIG. 11B illustrates the cover system illustrated in FIG. 11A in cross-sectional elevational view. The ground cover system 200 comprises the geomembrane 14 having the opposing surfaces 16, 18 and overlies in contacting relation to the surface 202. The geomembrane 14 typically is an elongated sheet provided in a selected width as a rolled material of a selected length, for unrolling and disposing over the surface in adjacent abutting relation. The wind-disturbing layer 20 overlies the geomembrane 14 on the upper surface 16. The wind-disturbing layer 20 is characterized as a light-weight, high pore opening asperity-defining structural blanket, layer, fabric, or mesh assembly of fibers or interconnected strands of fibers. The wind-disturbing layer 20 induces in situ turbulence of wind 52 in the air-flow turbulence zone 54 between the geomembrane 14 and the boundary 53 proximate the open-pore layer 20 and with a separation or gap between the geomembrane 14 and the boundary 53 with the laminar flow wind. The boundary 53 is proximate a layer that defines a transition from turbulent flow of wind in the turbulence zone 52 to laminar flow 56 of the wind remote from the geomembrane. The separation moves the shear forces vertically from proximity to the geomembrane, which shear forces that otherwise tends to induce wind-uplift and wind-induced movement of the geomembrane overlying the ground surface.

The wind-disturbing layer 20 in the illustrated embodiment comprises a web of a plurality of strands 204 joined together at overlaid intersections of two or more strands and defining openings 206 with a thickness of built-up stands. A distal edge (i.e., the outermost edge spaced from the geomembrane), of the wind-disturbing layer 20 defines an asperity extent 208. The asperity extent 208 is spaced from an opposing bottom edge 209 that sits in contact with the upper surface 16 of the geomembrane 14. The asperity extent 208 defines an uneven discontinuous distal portion of the open-pore wind disturbing layer 20.

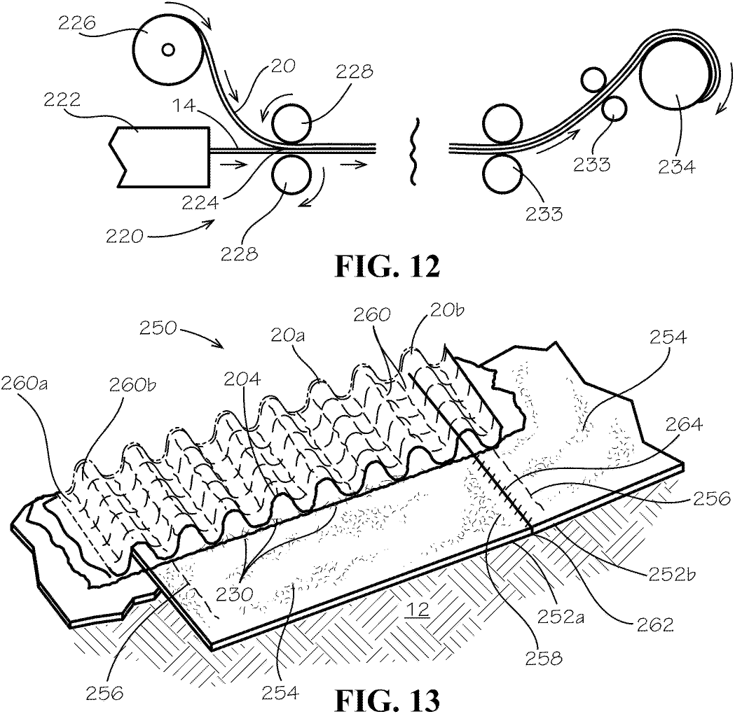

FIG. 12 illustrates a schematic diagram of a manufacturing system 220 for extrusion of the geomembrane 14 from an extruder 222 and attachment 224 of the air disturbing layer 20 in overlying relation supplied from a roll 226. The air disturbing layer 20 passes between feed rollers 228 in opposing relation. The feed rollers 228 guide tacking attachments 230 (as best illustrated in FIG. 13) of contacting portions of the strands 204 or fibers of the air disturbing layer 20 with the upper surface of the geomembrane 14. The heated extruded sheet of the geomembrane 14 receives and engages portions of the air disturbing layer 20 as the tacking attachments 230. In an alternate embodiment, the rollers 228 may be heated, and may provide a calendaring pressure for embedding portions of the strands or fibers into the geomembrane. The periodic tacking attachments 230 provide an engaged two-layer cover system 232 passing between guide roller 233 for rolling 234 into a roll, which is supplied to a site for covering with the cover system as disclosed herein. The tacking attachments 230 provide a slight boding of the two layers for interim holding during rolling for inventory, shipping, and installation at a site.

FIG. 13 illustrates a perspective view of a cover system 250 having a geomembrane 252 and the overlay of the air disturbing layer 20 in accordance with the present invention. The geomembrane 252 is an alternate embodiment of the geomembrane 14. The geomembrane 252 illustrates optionally surface texturing 254 with the periodic tacking attachments 230 joining the air disturbing layer 20 in engaged relation to the geomembrane. In the illustrated embodiment, the opposing margins 256, 258 are free of attachments 230 such that the margin portions of the air disturbing layer 204 are displaceable flaps 260. The displaceable flaps 260 allow passage of a seaming device for joinder of adjacent sheets of the geomembrane along a seam 262. In the illustrated embodiment, the seam 262 is formed by thermal bonding 264 of opposing edges of adjacent sheets 252a, 252b. Consistent with the present invention, the opposing edges of adjacent sheets of the air disturbing layer 20 are not joined or engaged whether overlaid freely or including periodic tacking attachments 230. As noted above, adjacent lengths of the wind-disturbing layers 20a, 20b may be positioned with abutting opposing side edges 60 or may positioned in overlapping relation with a respective side portion or flap 260a of one layer 20a overlapping a side portion or flap 260b of the adjacent wind-disturbing layer 20b.

A method of covering a surface with a cover system that resists wind uplift of the cover system is disclosed. More particularly in reference to the illustrative embodiments, the foregoing discloses a method of covering a large area ground surface, such as a landfill or laydown area, with a ground cover system that resists wind uplift. In reference to FIG. 4, a first geomembrane 14 is installed from the upper or uphill portion 81 downwardly downhill to the lower portion 82, and additional lengths of the geomembrane 14 are positioned in adjacent relation. The opposing edges 82, 84 of adjacent geomembranes 14 join together such as by heat sealing or welding to provide an impervious joint in the geomembrane of the ground cover 10. The geomembrane is overlaid with the wind-disturbing layer 20 similarly provided as a rolled fabric and installed onto the geomembrane in adjacent longitudinal mats. The width of the wind-disturbing layer 20 may be different than the width of the geomembrane to avoid aligned edges of the overlaid geomembrane. Opposing edges of the adjacent wind-disturbing layers may abut or overlap. The installation of the wind-disturbing layer 20 does not require ballasting such as with sandbags, tires and ropes, anchorages, cement blocks or other mass devices for holding the geomembrane 14 from movement under wind loading. Although not necessary, the perimeter edges of the leading and trailing ends of the wind-disturbing layers 20 may be buried in a trench as a termination point. As explained in reference to FIGS. 12 and 13, the ground cover system may be provided as a multi-layer system in which the wind-disturbing layer connects to the geomembrane with the plurality of tacking attachments 230, for a unitary ground covering for a large area site.

The illustrative cover system comprises at least two elongated geomembranes disposed in adjacent relation and bonded together at adjacent opposing edges; and at least two elongated layers overlaid on the geomembranes and disposed in adjacent relation, each of said two elongated layers having respective side edge portions, and the side edge portion of a first one of the two elongated layers overlapping the side edge portion of a second one of the two elongated layer.

While the present invention has been presented in alternate embodiments for ground cover systems for temporary site closure, the feature of the air disturbing layer may gainfully be used in other applications that experience high wind shear against surfaces for which surface movement or uplift in response to wind flow is desirable reduced or controlled. For example, the air disturbing layers disclosed herein may gainfully be overlain on roof surfaces such a shingle roofs or membrane roofs.

The foregoing particularly discloses a cover system for preventing water ingress into a surface, comprising:
a geomembrane layer; and
a wind-disturbing open-pore layer adjacent an upper surface of the geomembrane layer and defining an asperity extent, said open-pore layer for forming in situ an air-flow turbulence zone between the upper surface of the geomembrane layer and a boundary space proximate the open-pore layer, which boundary layer defines a transition from turbulent flow of wind in the turbulence zone to laminar flow of the wind remote from the geomembrane layer, said open-pore layer for inducing disturbance of a wind flow into and through the layer, whereby a suction force on the geomembrane is disturbingly broken by turbulent wind shear events therein and exerted downward pressure deflections, wherein the wind speed and pressure differential lessen and the geomembrane resists uplift.

With reference to FIG. 1 and further disclosures of the illustrative embodiments of mesh structures overlying the geomembrane, the ground cover system 10 operates for reducing wind flow velocity proximate the covered ground surface and resisting uplift movement of the geomembrane. Movement of the geomembrane creates ripples and stretched portions that may wear or tear. The wind 50 flows into the wind-disturbing layer 20 through the pores 32 and across the cover system 20 and the geomembrane 14. The wind-disturbing layer 20 induces in situ turbulent wind 52 within the wind turbulence zone 54 and downward pressure such as the jetties 57 against the geomembrane. The wind velocity is reduced within the wind turbulence zone 54 increasing towards the wind transition boundary 53 into the higher velocity laminar flow 56. For example, the ground cover system experiencing laminar wind 56 velocity of 50 miles per hour may have a significantly reduced turbulence zone 54 wind velocity of 10 miles per hour proximate the geomembrane 14. The greater the vertical distance spacing of the boundary line 53, and thus, the spacing of the laminar flow 56, from the geomembrane 14, the less suction shear force is applied by the wind flow to the ground cover 10 and particularly to the water impermeable geomembrane. Further, the downward wind forces such as turbulent jetties 57 bend the mesh such as the ridges 60, 128 downwardly. The ridges and the mesh defining the asperity extent 38 interrupt the wind flow and the resulting shear force of the turbulent wind in the turbulence zone tends to cause the mesh layer to bend or deflect downwardly producing a downward force or pushing on the geomembrane 14 below the wind-disturbing layer 20. This increases the resistance of the ground cover system to wind-uplift. The laminar flow 56 is vertically spaced from the geomembrane and the pulling of the shear force of the wind is significantly reduced. The porosity of the mesh defined by the plurality of openings formed by the interconnected or adjacent fibers breaks the suction of the wind and thereby cooperatively reducing uplift forces on the geomembrane-based ground cover system. The downward pressure of the turbulent wind flow in the turbulence zone 54 produces a downward deflection or bending of the mesh downwardly against the geomembrane for resisting uplift movement forces on the geomembrane. The present disclosed ground cover system with the wind-disturbing layer 20 thereby effectively develops in situ a wind-shield structure deflecting or separating the higher velocity laminar flow wind 56 from wind shear onto the geomembrane. The ground cover system 10 thereby resists wind-uplift that causes movement of the geomembrane without the need of additional ballasting, anchorage, or the like.

The foregoing discloses illustrative embodiments of a cover system for preventing water ingress into a surface while disturbingly breaking a suction force arising from turbulent wind shear events flowing thereover and exerted downward pressure deflections, wherein the wind speed and pressure differential lessen and the geomembrane resists uplift. While the invention has been described with particular reference to various embodiments, variations and modifications can be made without departing from the scope of the invention recited in the appended claims.

What is claimed is:

1. A cover system for preventing water ingress into a surface, comprising:
a geomembrane layer; and
a wind-disturbing open-pore layer adjacent an upper surface of the geomembrane layer and defining an asperity extent, said open-pore layer for forming in situ an air-flow turbulence zone between the upper surface of the geomembrane layer and a boundary space proximate the open-pore layer, which boundary layer defines a transition from a turbulent flow of wind in the turbulence zone to a laminar flow of the wind remote from the geomembrane layer, said open-pore layer for inducing disturbance of the wind flow into and through the open-pore layer, whereby a suction force on the geomembrane is disturbingly broken by a plurality of turbulent wind shear events therein and said plurality of turbulent wind shear events exerting downward pressure deflections, wherein the wind speed and pressure differential lessen and the geomembrane resists uplift.

2. The cover system as recited in claim 1, wherein wind-disturbing open-pore layer defines an undulating asperity extent.

3. The cover system as recited in claim 2, wherein the undulating asperity extent is defined by a mesh having a wavelike edge of open-pore alternating ridges and valleys.

4. The cover system as recited in claim 3, wherein the mesh comprises a plurality of random laid fibers forming a vertically-thick, elongated assembly.

5. The cover system as recited in claim 5, wherein the fibers occupy a minor portion of the thickness of the assembly and define in a majority portion of the thickness a plurality of air-flow pathways through the open-pore layer.

6. The cover system as recited in claim 4, wherein the fibers interconnect at contacting connections of strands of fibers.

7. The cover system as recited in claim 6, wherein the fibers occupy a minor portion of the thickness of the assembly and define in a majority portion of the thickness a plurality of air-flow pathways through the open-pore layer.

8. The cover system as recited in claim 1, wherein the upper surface of the geomembrane defines a texturing for a mechanical connection between the geomembrane and the open-pore layer.

9. The cover system as recited in claim 1, wherein the geomembrane further comprises a plurality of spaced-apart projections extending from the upper surface, said projections for mechanically connecting the geomembrane and the open-pore layer together.

10. The cover system as recited in claim 9, wherein the geomembrane further comprises a plurality of spaced-apart stubs extending from an opposing bottom surface, for mechanical engagement of the geomembrane to a penetrable surface.

11. The cover system as recited in claim 1, further comprising at least two elongated geomembranes disposed in adjacent relation and bonded together at adjacent opposing edges; and at least two elongated layers overlaid on the geomembranes and disposed in adjacent relation, each of said two elongated layers having respective side edge portions, and the side edge portion of a first one of the two elongated layers overlapping the side edge portion of a second one of the two elongated layers.

12. The cover system as recited in claim 1, wherein the open pore layer comprises a base mesh layer and an attached superstructure layer, said base mesh layer connecting to the upper surface of the geomembrane and said superstructure layer comprising a volumetric open-pore profile of fibers that define the asperity extent remote from the geomembrane.

13. The cover system as recite in claim 12, wherein the base layer is substantially planar.

14. The cover system as recited in claim 12, wherein the volumetric open-pore profile has a variable thickness along a longitudinal axis of the elongated layer, whereby the layer defines an undulating profile.

15. The cover system as recited in claim 14, wherein the undulating profile comprises alternating ridges and valleys.

16. The cover system as recited in claim 12, further comprising a geotextile disposed between the base layer and the superstructure layer.

17. The cover system as recited in claim 1, further comprising a plurality of fiber sticks distributed between the between the base layer and the superstructure layer.

18. The cover system as recited in claim 17, wherein the plurality of fiber sticks are carried on a netting, and the netting, the base layer, and the superstructure layer engaged together.

19. The cover system as recited in claim 18, further comprising a sewed thread interwoven for engaging the netting, the base layer, and the superstructure layer together.

20. The cover system as recited in claim 1, wherein a bottom portion of the open-pore layer bonds at spaced-apart contacting points to the geomembrane.

21. The cover system as recited in claim 20, wherein the geomembrane defines surface texturing.

22. The cover system as recited in claim 20, wherein the bonded open-pore layer defines a flap on a side edge portion that is unbonded to the geomembrane, which flap is displaceable for passage of a seaming device for joinder of opposing edges of adjacent geomembranes.

23. A method of reducing wind uplift of a cover system preventing water ingress into a surface, comprising the steps of:
(a) providing a geomembrane layer; and
(b) overlying the geomembrane layer with a wind-disturbing open-pore layer that defines an asperity extent, said open-pore layer for forming in situ an air-flow turbulence zone between the upper surface of the geomembrane layer and a boundary space proximate the open-pore layer, which boundary layer defines a transition from a turbulent flow of wind in the turbulence zone to a laminar flow of the wind remote from the geomembrane layer, said open-pore layer for inducing disturbance of the wind flow into and through the open-pore layer, whereby a suction force on the geomembrane is disturbingly broken by a plurality of turbulent wind shear events therein and said plurality of turbulent wind shear events exerting downward pressure deflections, wherein the wind speed and pressure differential lessen and the geomembrane resists uplift.
